(19) United States
(12) Patent Application Publication
(10) Pub. No.: US 2006/0209738 A1
(43) Pub. Date: Sep. 21, 2006

(54) Digital satellite broadcast system, transmission station, and receiver

(75) Inventor: Hitoshi Ikeda, Ikoma-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/354,873

(22) Filed: Feb. 16, 2006

(30) Foreign Application Priority Data
Feb. 17, 2005 (JP) 2005-039967

(51) Int. Cl. H04B 7/185; H04B 7/204

(52) U.S. Cl. 370/316; 370/319

(57) ABSTRACT

A signal for each of channels to be sent to a receiver is provided with a time zone in which nothing needs to be received, so that if an instruction is given by a user to simultaneously receive a plurality of channels assigned to different frequencies, program information of the plurality of channels can be acquired when a tuner section switches the frequency for a specified channel by utilizing the time zone.

This application is based on Japanese Patent Application No. 2005-039967 filed on Feb. 17, 2005, the contents of which are hereby incorporated by reference.

### BACKGROUND OF THE INVENTION

1. Field of the Invention

The present invention relates to a digital broadcast satellite system. More particularly, the present invention relates to a digital broadcast satellite system that can receive a plurality of broadcast programs simultaneously.

2. Description of the Prior Art

Recently, a digital satellite broadcast system is being used more and more which digitizes a TV signal and transmits it via an artificial satellite such as a communication satellite or a broadcast satellite so that each of homes can receive this transmitted signal and view a program based on the signal.

In each of a plurality of transponder signals transmitted from a transponder of the satellite, a video signal, an audio signal and the like are multiplexed. The transponder signals have different frequencies.

A receiver is equipped with a tuner, so that a signal having one frequency specified by the tuner is input into the receiver, where the signal undergoes predetermined processing and then is output as the video signal and the audio signal.

In configuration, the receiver has a table that describes frequencies of transponder signals that includes channel numbers and programs that correspond to the channel numbers, and in accordance with a channel specified by a user through a wireless remote controller or the like the tuner tunes in to a frequency of a transponder signal that includes a signal of this channel so that this transponder signal may be received.

That is, in a condition where a channel included in a transponder signal having one frequency is received, in order to further receive a channel included in another transponder signal having a different frequency, the receiver needs to have a configuration that can receive different two frequencies, and in fact, receivers having such a configuration are provided conventionally (see, for example, JP-A 11-8847 (1999))

Such a receiver described in JP-A 11-8847 (1999) as to comprise a plurality of reception systems is equipped with a plurality of tuners for transponder signals having different frequencies.

Therefore, when a program of a channel is being video-recorded as viewing a program of another channel on TV, even if signals of these channels are included in transponder signals having different frequencies, these transponder signals can both be received, so that one program can be video-recorded as viewing another program.

However, a receiver having such a configuration needs to be equipped with a plurality of tuners and so has a problem that the receiver itself may be increased in size.

Further, the plurality of tuners are driven simultaneously to simultaneously receive signals having different frequencies, so that a problem occurs which requires larger power consumption.

### SUMMARY OF THE INVENTION

The present invention has been developed to solve these problems, and it is an object of the present invention to provide a digital satellite broadcast system that can simultaneously receive a plurality of broadcast programs included in signals having different frequencies, by using a receiver equipped with a single tuner.

It is another object of the present invention to provide a reception station and a receiver which are utilized in this digital satellite broadcast system.

In order to achieve these objects, a digital satellite communication system of the present invention comprises: a transmission station for transmitting a signal including program information; a satellite for relaying the signal transmitted from the transmission station; and a receiver for receiving the signal relayed by the satellite, to acquire the program information when predetermined processing is performed on the basis of this signal. Herein, the receiver includes a tuner section for selecting a frequency of the signal to be received, and first and second output sections for outputting to an external device the program information acquired from the signal included in one frequency selected by the tuner section. When supplied with an instruction to receive a first channel included in the signal having a first frequency and a second channel included in the signal having a second frequency, the tuner section performs switchover control on the first frequency and the second frequency at a predetermined time interval, the program information of the first channel is restored on the basis of the signal received when the first frequency is selected, and sent out to the first output section, and the program information of the second channel is restored on the basis of the signal received when the second frequency is selected, and sent out to the second output section.

According to a configuration of the present invention, in each of the channels, packets in which data of a program is described are arranged at every predetermined time interval or as many as a predetermined number to thereby configure a stream, so that there occurs a time zone in which no data for a specified one of the channels is included or a time zone in which already acquired data is flowing. Therefore, by changing a receive stream by switching a reception frequency in this time zone, it is possible to further acquire data for a channel included in a stream having a different frequency. It is thus possible to simultaneously receive programs in a plurality of frequencies by using a receiving set equipped with a single tuner.

### DESCRIPTION OF THE DRAWINGS

FIG. 1 is a conceptual diagram of a communication system according to one embodiment;

FIG. 2 is a block diagram showing a configuration of a transmission station;

FIG. 3A and FIG. 3B show one example of a configuration of the TS;

FIG. 4 is a block diagram showing a configuration of a receiver;

FIG. 5 shows one example of a configuration of the TS for another channel;

FIG. 6 shows one example of a configuration of the TS for still another channel;

FIG. 7 shows one example of a configuration of a TS according to a second embodiment;

FIG. 8 shows one example of the configuration of the TS for a different channel according to the second embodiment;

FIG. 9 is a block diagram showing a configuration of a transmission station according to a third embodiment;

FIG. 10 shows one example of a configuration of a TS according to the third embodiment;

FIG. 11 shows another example of a configuration of the TS according to the third embodiment; and

FIG. 12 shows an example of another configuration of the TS according to the third embodiment.

### DESCRIPTION OF THE PREFERRED EMBODIMENTS

### First Embodiment

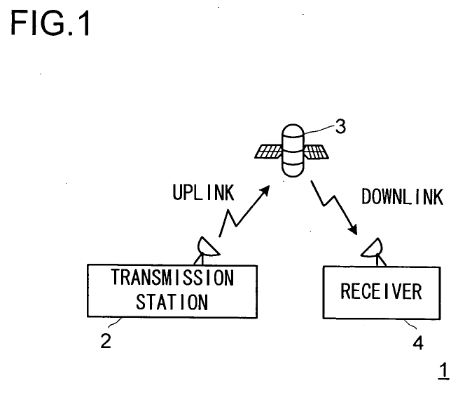

The following will describe the first embodiment of the present invention with reference to the drawings. FIG. 1 is a conceptual diagram showing a configuration of a communication system according to one embodiment of a video display of the present invention.

A communication system 1 of FIG. 1 comprises a transmission station 2 for transmitting (uplinking) a broadcast signal including AV data from an antenna, a satellite 3 equipped with a plurality of transponders to thereby relay the broadcast signal from the transmission station 2, and a receiver 4 installed on the ground and equipped with a receiving set for receiving (downlinking) the signal transmitted from the transponder.

In the transmission station 2, the same AV data is recomposed for each of packets to generate a plurality of broadcast signals, which are transmitted in different channel frequencies. When the plurality of broadcast signals generated from the same AV data are received by the receiver 4 via the satellite 3, data pieces obtained from this plurality of broadcast signals are composed to reproduce the original AV data.

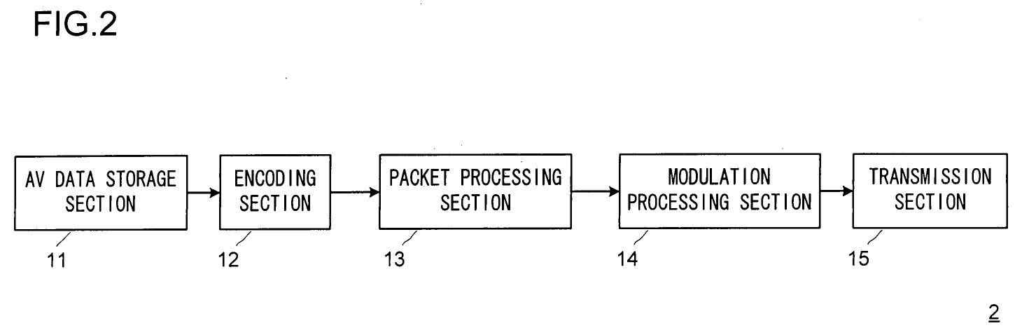

FIG. 2 is a block diagram showing a configuration of the transmission station 2. The transmission station 2 includes an AV data storage section 11 for storing video data and audio data, which compose a program, an encoding section 12 for generating an elementary stream (ES) by digitally encoding in accordance with the motion picture expert group (MPEG) standard the AV data supplied from the AV data storage section 11, a packet processing section 13 for packetizing each predetermined unit of the ES obtained by the encoding section 12 to thereby generate a plurality of packetized elementary streams (PESs) and integrating this plurality of PESs and program specific information (PSI)/service information (SI) to thereby generate a fixed-length transport stream (TS) packet string, a modulation processing section 14 for adding an error correction code to avoid an transmission error to the TS packet generated by the packet processing section 13 and performing modulation processing to thereby generate a high-frequency signal, and a transmission section 15 for transmitting to the satellite 3 the high-frequency signal output from the modulation processing section 14.

In the transmission station 2, when AV data of contents provided from the AV data storage section 11 is supplied to the encoding section 12, the encoding section 12 digitally encodes the AV data to thereby generate an ES and outputs it to the packet processing section 13.

The packet processing section 13 packetizes each predetermined unit of the ES supplied from the encoding section 12 to thereby generate a PES. The PES is generated in accordance with a type of information such as audio and video and formed by, for example, delimiting the information at the same time interval. Further, a header of each of the PESs includes information (hereinafter, described as “reproduction time information”) of time at which the side of the receiver reproduces an audio signal and a video signal that compose this PES.

Moreover, the packet processing section 13 divides (TS-packetizes) a PES that composes thus generated video data or audio data into fixed-length portions and multiplexes them to thereby form a TS signal. In this case, each of the TS packets is provided with a packet ID (PID) for identification, so that the TS packets into which the same PES is divided are provided with the same PID. Further, this TS signal is provided with PSI/SI that describes information about each PES. This PSI/SI stores information about PESs that compose the TS packet, so that the receiver 4 can extract based on this PSI/SI the TS packet provided with the corresponding PID, thereby reproducing the PES from this TS packet.

In this embodiment, it is assumed that a TS signal is formed by serially arranging a predetermined number of TS packets including the same information and that headers of TS packets including the same information are each provided with partial packet information (hereinafter, referred to as “PPID”) which indicates that the same information is included therein.

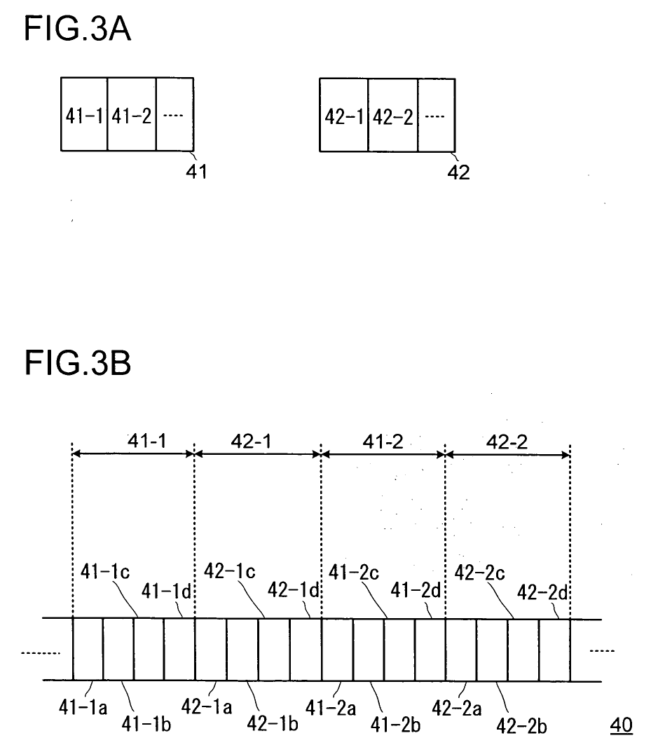

FIG. 3A and FIG. 3B show one example of a configuration of a TS. A single TS 40 shown in FIG. 3B is partially composed of a PES 41 and a PES 42 shown in FIG. 3A.

First, the PES 41 and the PES 42 are divided into parts each of which has a predetermined size to thereby generate partial PESs 41-1, 41-2, . . . , and partial PESs 42-1, 42-2, . . . , respectively.

Then, TS packets 41-1a, 41-1b, 41-1c, and 41-1d formed from the partial PES 41-1 are serially arranged, and headers of the respective TS packets are each provided with the same PID “41p” indicating that they are formed from PES 41 and the same PPID “p41p−1” indicating that they are formed from the same partial PES 41-1 of the same PES 41.

Next, similar to the aforementioned description, TS packets 42-1a, 42-1b, 42-1c, and 42-1d formed from a partial PES 42-1 are serially arranged following the TS packet 41-1d, and headers of the respective TS packets are each provided with the same PID “42p” indicating that they are formed from a PES 42 and the same PPID “p42p−1” indicating that they are formed from the same partial PES 42-1 of the same PES 42.

Next, TS packets 41-2a, 41-2b, 41-2c, and 41-2d formed from a partial PES 41-2 are serially arranged following the TS packet 41-2d, and headers of the respective TS packets are each provided with the same PID “41p” indicating that they are formed from the PES 41 and the same PPID “p41p−2” indicating that they are formed from the same partial PES 41-2 of the same PES 41.

Similarly, TS packets 42-2a, 42-2b, 42-2c, and 42-2d formed from a partial PES 42-2 are serially arranged following the TS packet 41-2d, and headers of the respective TS packets are each provided with the same PID “42p” indicating that they are formed from the PES 42 and the same PPID “p42p−2” indicating that they are formed from the same partial PES 42-2.

By thus configuring a TS signal, the side of the receiver 4 can receive at least one of TS packets each of which is provided with the same PPID, thereby acquiring a partial PES corresponding to this PPID. Therefore, for example, in a case shown in FIG. 3, since TS packets 41-1a, 41-1b, 41-1c, and 41-1d are each provided with PPID “p41p−1”, partial PES 41-1 can be acquired as far as the TS packet 41-1d can be received even if the other three TS packets 41-1a, 41-1b, and 41-1c cannot be received for any reason, so that a PES 41 can be restored by combining the partial PES 41-1 with the other partial PESs 41-2, . . . .

Similarly, when the side of the receiver 4 receives at least one of TS packets provided with PPIDs of p42p−1, p42p−2, . . . , partial PESs 42-1, 42-2, . . . , can be acquired, so that the PES 42 can be restored on the basis of partial PESs 42-1, 42-2, . . . , being acquired. In such a manner, the receiver 4 restores each PES from a TS signal formed by separating and multiplexing a plurality of PESs.

It is to be noted that operations of the receiver 4 in a case where it has received a TS signal having such a configuration are described in detail later.

Although FIG. 3A and FIG. 3B show that a TS signal is formed by serially arranging the same four TS packets, the number of the serially arranged same packets is not limited to four but any predetermined number of TS packets may be generated serially.

The TS signal composed by thus arranging TS packets generated by the packet processing section 13 is provided with an error correction code by the modulation processing section 14 and then subjected to modulation processing in accordance with a predetermined modulation scheme such as quadrature phase shift keying (QPSK). Then, it is converted by a frequency conversion section (not shown) into a high-frequency signal and then transmitted from the transmission section 15.

The high-frequency signal transmitted from the transmission section 15 is subjected to amplification and frequency conversion by the transponder equipped to the satellite 3 and then emitted toward the receiver 4. At least two transponders are equipped to the satellite 3, so that the signal is synchronized between these transponders and then emitted. Further, frequencies of the signals to be emitted from the different transponders are set to different values.

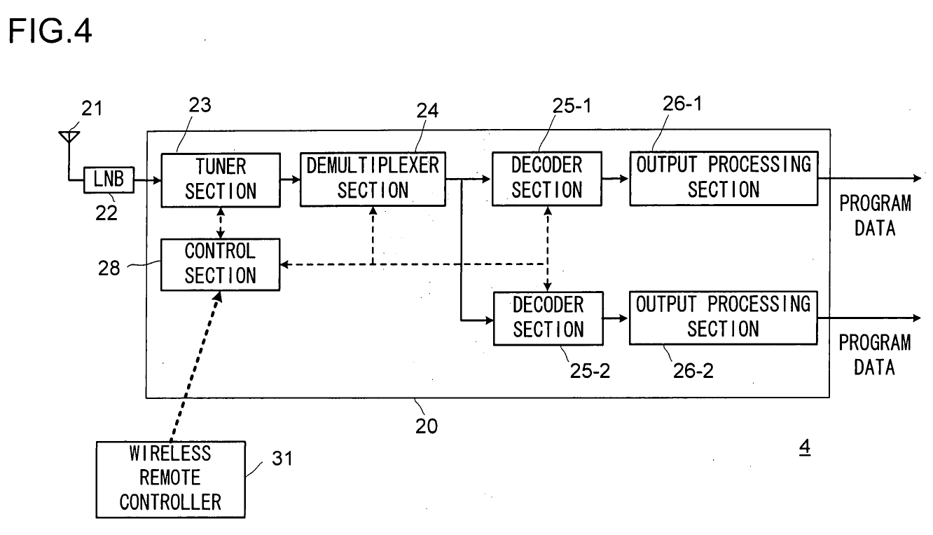

FIG. 4 is a block diagram showing a configuration of the receiver 4. The receiver 4 includes a reception antenna 21 for receiving a signal emitted from the satellite 3, a low noise block down converter (LNB) 22 for performing frequency conversion on the signal received through the antenna 21, and a set top box (STB) 20 for performing predetermined processing on an output signal of the LNB 22 to thereby extract a video signal and an audio signal. When the output signal of this STB 20 is input to a TV set or the like, a viewer can recognize video information and audio information. It is to be noted that in FIG. 4, a solid line indicates a flow of program data and a dotted line indicates a flow of a control signal.

The STB 20 includes a tuner section 23 for selectively receiving only such a signal of the output signals of the LNB 20 as to have a desired frequency and performing demodulation processing and error correction processing on the received signal to thereby acquire a TS signal, a demultiplexer section 24 for separating each of multiplexed TS packet signals from the TS signal taken in by the tuner section 23, decoder sections 25-1 and 25-2 for performing decoding processing based on the TS packet signals separated by the demultiplexer section 24, and an output processing section 26-1 for converting data output from the decoder 25-1 into a predetermined format in order to output it as video and audio to an external device. The STB 20 further includes a similar output processing section 26-2 for converting data output from the decoder section 25-2 into a predetermined format in order to output it as video and audio to the external device. From the output processing sections 26-1 and 26-2, a video signal and an audio signal that composes a program are output.

In configuration, for example, by connecting a TV set to the output processing section 26-1 and connecting a video cassette recorder to the output processing section 26-2, it is possible to view an video signal and an audio signal provided from the output processing section 26-1 while saving (video-recording) a video signal and an audio signal provided from the output processing section 26-2.

The STB 20 further includes a control section 28 for controlling operations of the tuner section 23, the demultiplexer section 24, and the decoder sections 25-1 and 25-2. Each of the tuner section 23, the demultiplexer section 24, the decoder sections 25-1 and 25-2, and the output processing sections 26-1 and 26-2 is equipped with a buffer for storing data temporarily.

A user selects a channel to be received, by operating a wireless remote controller 31. An operation on the wireless remote controller 31 is given to the control section 28, which in turn instructs the tuner section 23 to select a frequency of the channel desired by the user. In this case, a memory (not shown) in the STB 20 may be assumed to store beforehand a frequency table that correlates an operation on the wireless remote controller and information of the corresponding channel and frequency so that based on this frequency table the control section 28 can give an instruction to the tuner section 23.

It is assumed herein, for example, that the user has operated the wireless remote controller 31 to give an instruction to the effect that a channel ch40 should be received. The control section 28 instructs the tuner section 23 to selectively receive a TS signal having a frequency f40 that corresponds to the channel ch40. The tuner section 23 selectively receives the TS signal having frequency f40, demodulates it, and outputs it to the demultiplexer section 24.

The demultiplexer section 24 extracts from the TS signal provided by the tuner section 23 a PSI that describes information of each of TS packets included in this TS signal and, based on this information in the PSI, separates and extracts the TS packets for each of desired components (video data, audio data and the like), and then outputs them to the following-stage decoder section 25-1.

The decoder section 25-1 first restores a PES from the TS packets, provided with the same PID, which are supplied from the tuner section 23. In this case, as described above, among a plurality of TS packets of a TS, there are at least two TS packets (i.e., TS packets provided with the same PPID) that are formed by dividing the same part of the same PES, so that any one of these TS packets may be selected and utilized in restoration of the PES.

In this example, it is assumed that one part of the TS signal having frequency f40 supplied from the tuner section 23 to the demultiplexer section 24 has such a structure shown in FIG. 3B. Then, the demultiplexer section 24 separates multiplexed information based on the PID given to each of the TS packets.

First, when supplied with a TS packet 41-1a, the demultiplexer section 24 confirms that the PID provided to its header is “41p” and outputs it to the decoder section 25-1. Based on that the PID is “41p” and the PPID is “p41p−1”, the decoder section 25-1 recognizes that the TS packet 41-1a is a partial PES 41-1 composed of one part of a PES 41 and stores it in the buffer until other partial PESs necessary for restoration of the PES 41 are provided.

Next, when supplied with a TS packet 41-1b, the demultiplexer section 24 confirms that the PID provided to its header is “41p” and outputs it to the decoder section 25-1. Based on that the PID is “41p” and the PPID is “p41p−1”, the decoder section 25-1 recognizes that it is a TS packet in which the same information as that of the TS packet stored in the buffer is described and abandons this TS packet. The same processing is performed on the TS packets 41-1c and 41-1d.

Further, similarly, when supplied with a TS packet 42-1a, the demultiplexer section 24 confirms that the PID provided to its header is “42p” and outputs it to the decoder section 25-1. Based on that the PID is “42p” and the PPID is “p42p−1”, the decoder section 25-1 recognizes that the TS packet 42-1a is a partial PES 42-1 composed of one part of a PES 42 and stores it in the buffer until other partial PESs necessary for restoration of the PES 42 are provided.

Then, as in the case of the TS packet 41-1b, when the demultiplexer section 24 is supplied with a TS packet 42-1b, based on that the PID is “42p” and the PPID is “p42p−1”, the decoder section 25-1 recognizes that it is a TS packet in which the same information as that of the TS packet stored in the buffer is described and abandons this TS packet. The same processing is performed on the TS packets 42-1c and 42-1d.

Subsequently, similarly, TS packets that compose the TS signal are given to the decoder section 25-1. In this case, when the TS packets (i.e., TS packets whose PID are “41p”) necessary for restoring, for example, PES 41 are all stored in the buffer, the PES 41 is restored by using these TS packets in the decoder section 25-1. Further, if information that indicates audio data is described in the PES 41, the information in this PES 41 is restored to the audio data in the decoder section 25-1.

Then, the restored audio data is stored in the buffer temporarily, time-adjusted on the basis of information about reproduction time provided to this PES so that this audio data can be reproduced at this reproduction time, and sent out to the output processing section 26-1.

The output processing section 26-1 converts (A/D conversion) the provided audio data into such a format as to enable outputting audio and outputs this converted signal to the external device. This output signal is input to a speaker or the like connected to the external device to be heard by the user.

Similarly, in a case where a PES 42 is video data, when TS packets required to restore the PES 42 are all stored in the buffer, the decoder section 25-1 restores the PES 42 from these TS packets, from this PES 42, video data is restored. The restored video data is stored in the buffer temporarily, time-adjusted on the basis of information about reproduction time provided to this PES so that this video data can be reproduced at this reproduction time, and sent out to the output processing section 26-1. The output processing section 26-1 converts (NTSC conversion or the like) the provided video data into such a format as to enable outputting video and outputs this converted signal to the external device. This output signal is input to a monitor or the like connected to the external device to be viewed by the user.

By such a configuration, the user can view and hear video information and audio information of the channel ch40 on a TV set or the like. The following will describe the case of further receiving a signal of a channel ch50 different from the channel ch40 in this condition. It is assumed that the signal of the channel ch50 is included in a TS signal having a frequency f50 different from the frequency f40.

It is assumed that the user has operated the wireless remote controller 31 to instruct to receive the channel ch50 while receiving the channel ch40 simultaneously. The control section 28 recognizes based on a signal from the wireless remote controller 31 that an instruction has been received to the effect that a mode (hereinafter, referred to as “simultaneous reception mode”) should be entered for receiving the different two channels. Further, the control section 28 instructs the tuner section 23 to receive the channel ch40 and the channel ch50 simultaneously.

The tuner section 23 receives signals as making switchover at a predetermined timing between the TS signal frequency f40 of the channel ch40 and the TS signal frequency f50 of the channel ch50. This timing is explained below.

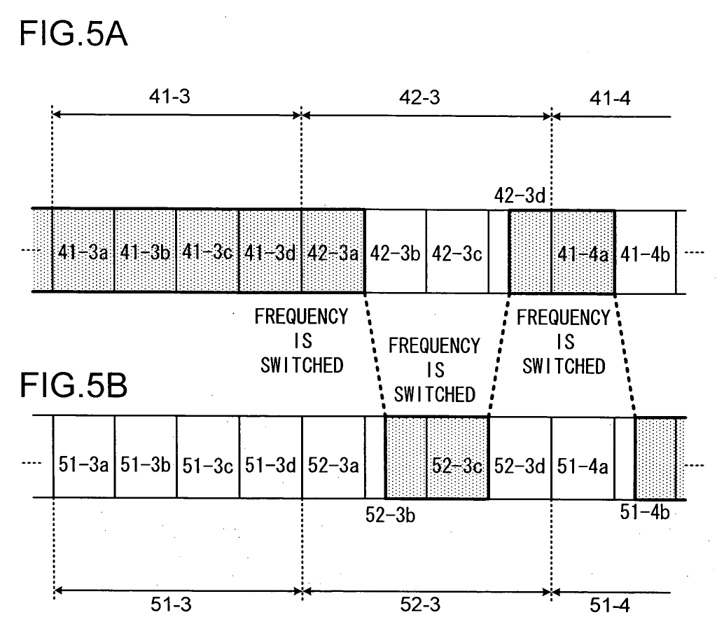

FIG. 5 shows a configuration example of TS signals of the channel ch40 and the channel ch50 received by the antenna 21. In FIG. 5, (a) shows a configuration of the channel ch40 and (b) shows a configuration of the channel ch50.

TS packets are configured to have the same size and synchronized with each of TS signals when the TS signals are emitted from the transponder as described above, so that the TS packets that compose the TS signal of the channel ch40 (whose frequency is f40) and the TS packets that compose the TS signal of the channel ch50 (whose frequency is f50) are emitted to the antenna 21 at the same timing.

For example, a TS packet 41-3a included in a TS signal having frequency f40 and a TS packet 51-3a included in a TS signal having frequency f50 that are shown in FIG. 5 are made incident upon the antenna 21 at the same timing. Therefore, if the tuner section 23 is set so as to receive the TS signal of the frequency f40, the TS packet 51-3a cannot be received when the TS packet 41-3a is being received.

Conversely, if the tuner section 23 is set so as to receive the TS signal of the frequency f50, for example, the TS packet 41-3a cannot be received when the TS packet 51-3c is being received.

The following will describe a case where an instruction is given to receive the channel ch50 simultaneously when the channel ch40 is being received as described above in such a configuration.

The control section 28 instructs the tuner section 23 to receive the reception frequencies f40 and f50 simultaneously. It is assumed that, in this case, the STB 20 shifts into the simultaneous reception mode after a partial PES indicated by a TS packet being received currently is received completely.

For example, it is assumed that, in FIG. 5, the TS packet 41-3a is being received when the user has issued an instruction to receive the channel ch50 simultaneously. In such a case, the STB 20 shifts into the simultaneous reception mode after the tuner section 23 completely receives the group of TS packets (the TS packets 41-3a, 41-3b, 41-3c, and 41-3d) in which the same information is described.

When reception of the TS packet 41-3d is completed and the next TS packet 42-3a is received completely, the tuner section 23 switches the reception frequency from f40 to f50. Since switchover of the frequency takes a constant lapse of time, the TS packet 42-3b is partially received by a point in time when the switchover is completed, which received part of the TS packet 42-3b may be abandoned.

The TS packet 42-3a received in this case is confirmed by the demultiplexer section 24 that its PID is “42p” and output to the decoder section 25-1. Based on that the PID is “42p” and the PPID is “p42p−3”, the decoder section 25-1 recognizes that the TS packet 42-3a is a partial PES 42-3 composed of one part of the PES 42 and stores it in the buffer until the other partial PESs required to restore the PES 42 are provided.

On the other hand, the TS signal having the frequency f50 received immediately after switchover to the frequency f50 is in such a condition that a TS packet 52-3b is partially deficient. In this case, a header of the TS packet 52-3b cannot be confirmed, so that this data is also abandoned. When a TS packet 52-3c to be provided next is received, the demultiplexer section 24 confirms that a PID provided to its header is “52p” and outputs it to the decoder section 25-2.

Based on that the PID is “52p” and the PPID is “p52p−3”, the decoder section 25-2 recognizes that the TS packet 52-3c is a partial PES 52-3 composed of one part of a PES 52 and stores it in the buffer until the other partial PESs required to restore the PES 52 are provided.

When reception of the TS packet 52-3c is completed, the tuner section 23 switches the reception frequency from f50 back to f40. In this case also, similarly, the TS packet 52-3d is received partially by a point in time when the switchover is completed, which received part of the TS packet 52-3b may be abandoned.

Further, similarly, a header of the TS packet 42-3d which is received immediately after switchover of the frequency f40 cannot be confirmed, so that this data is also abandoned. When a TS packet 41-4a to be provided next is received, the demultiplexer section 24 confirms that a PID provided to its header is “41p” and outputs it to the decoder section 25-1.

Subsequently, similarly, each time reception of the TS packet is completed, the tuner section 23 switches the reception frequency. Further, the demultiplexer section 24 confirms a PID and sends out data for the channel ch40 to the decoder section 25-1 and sends out data for the channel ch50 to the decoder section 25-2.

In such a configuration, for TS signals of both channels, one of TS packets in which the same information is described can be received without fail, so that it is possible to acquire all TS packets required to restore a PES. Therefore, for example, when all the TS packets (TS packets whose PID is “41p”) required to restore the PES 41 are stored in the buffer, the decoder section 25-1 restores the PES 41 by using these TS packets, and when all the TS packets (TS packets whose PID is “52p”) required to restore the PES 52 are stored in the buffer, the decoder section 25-2 restores the PES 52 by using these TS packets.

Then, data restored in the decoder section 25-1 is stored in the buffer temporarily, time-adjusted on the basis of information about reproduction time provided to this PES so that this data can be reproduced at this reproduction time, and sent out to the output processing section 26-1. Similarly, data restored in the decoder section 25-2 is stored in the buffer temporarily, time-adjusted on the basis of information about reproduction time provided to this PES so that this data can be reproduced at this reproduction time, and sent out to the output processing section 26-2. Then, these data items are subjected to predetermined conversion processing at the output processing sections 26-1 and 26-2 respectively and output to the external device.

Therefore, the data (video, audio and the like) of the channel ch40 is output from the output processing section 26-1 and the data (video, audio and the like) of the channel ch50 is output from the output processing section 26-2, so that, for example, by connecting a TV set to the output processing section 26-1 and connecting a video cassette recorder to the output processing section 26-2 as described above, it is possible to respectively view and hear a video signal and an audio signal provided from the output processing section 26-1 while saving (video-recording) a video signal and an audio signal provided from the output processing section 26-2.

Although in the aforementioned configuration the TS signal is composed of serially arranged four TS packets in which the same information is described and a lapse of time required to switch the frequency is smaller than a lapse of time required to receive each of the TS packets, the present invention is not limited to this configuration.

That is, in the case of simultaneously receiving TS signals which are superimposed on the two frequencies f40 and f50 respectively, it is necessary that each of the TS signals should be composed of a serially arranged plurality of TS packets with the same size which describes therein the same information and synchronized with each other and that the TS packet that describes therein the same information as the TS packet which is acquired from the TS signal having the frequency f50 when one of the TS packets (which is assumed to be a TS packet 45-1a) of the TS signal having the frequency f40 is received should be able to be received after reception of the TS packet 45-1a is completed and the reception frequency is switched from f40 to f50.

Further, it is only necessary that at a point in time when the frequency is switched from f50 to f40 after reception of the TS packet with f50 is completed, the TS packet that describes therein the same information as the TS packet 45-1a already received should be flowing already and the TS packet that describes therein different information should start flowing at least after a point in time when the frequency is switched to f40. By such a configuration, occurrence of such a situation can be avoided that a TS packet required to restore a PES cannot be received when a signal having any other frequency is being received.

It is to be noted that the TS packets have the same size and it takes constant time to receive any of them completely, so that the tuner section 23 may consecutively switch the reception frequency each time a predetermined lapse of time elapses after the simultaneous reception mode is entered.

Although in this embodiment one of the identical TS packets that come serially has been utilized to restore a PES, parts of the respective two TS packets received may be combined with each other to acquire data described in the TS packets, so that the acquired data can be utilized to restore a PES. It is described below.

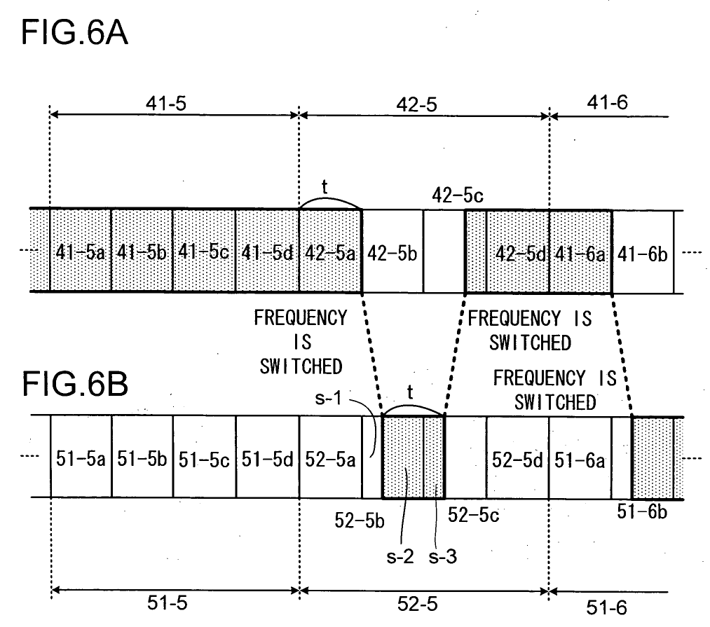

Like FIG. 5, FIG. 6 shows configurations of TS signals of the channel ch40 and the channel ch50 which are received by the antenna 21. In FIG. 6,

(a) shows the configuration of the channel ch40 and (b) shows the configuration of the channel ch50.

As described above, to receive ch40 and ch50 simultaneously, when reception of a TS packet 42-5a is completed, first the tuner section 23 switches the reception frequency from f40 to f50. Since this frequency switchover processing takes some lapse of time, one part s-1 of a TS packet 52-5b of ch50 cannot be received and only one part s-2 can be received.

When a predetermined lapse of time t elapses after switchover to the frequency f50, the tuner section 23 switches the reception frequency back to f40. This predetermined lapse of time t is assumed to be required to receive each of the TS packets.

In this case, when the reception frequency is at f50, the one part s-2 of the TS packet 52-5b and one part s-3 of the TS packet 52-5c are received. In this case, the same information is described in the TS packets 52-5b and the 52-5c, so that these parts s-2 and s-3 can be utilized to acquire data described in the TS packet 52-5b (52-5c, 52-5d).

After switchover to the frequency f40, the one part of the TS packet 42-5c and that of the TS packet 42-5d are abandoned and, after reception of a TS packet 41-6a is completed, the tuner section 23 switches the reception frequency to f50 again. Similarly, such switchover control is conducted subsequently.

In such a configuration, for TS signals of both channels, one of TS packets in which the same information is described can be received without fail, so that it is possible to acquire all TS packets required to restore a PES. Therefore, it is possible to acquire data about video and audio of both of the channels.

### Second Embodiment

The following will describe the second embodiment of the present invention with reference to the drawings. This embodiment is different from the first embodiment in configuration of a TS signal which is formed by a packet processing section 13 on the side of a transmission station 2 and hence in configuration of contents to be controlled by a control section 28 in a receiver 4 but are the same as the first embodiment in the other configurations, so that explanation of these configurations is omitted.

As in the case of the first embodiment, in this embodiment also, the packet processing section 13 in the transmission station 2 shown in FIG. 3 divides (TS-packetizes) a PES that composes the generated video data or audio data into fixed-length parts and multiplexes them to thereby form a TS signal. It is to be noted that in this embodiment a TS signal is composed by arranging TS packets at a predetermined time interval not by serially arranging TS packets including the same information as in the case of the first embodiment.

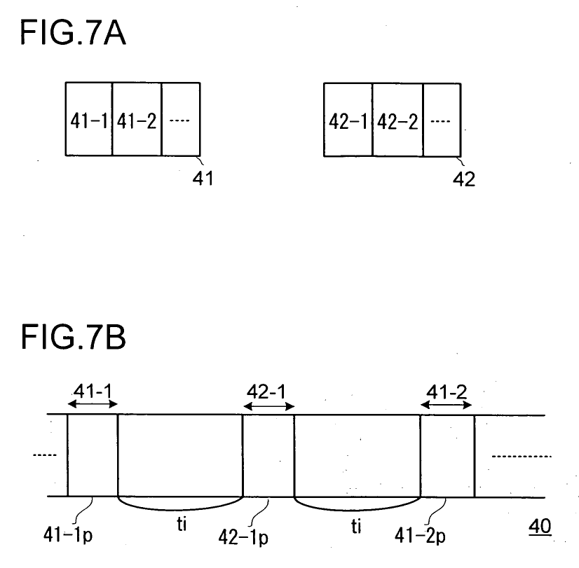

FIG. 7A and FIG. 7B show one example of a configuration of a TS which is formed in the transmission station 2 of this embodiment. A single TS 40 shown in FIG. 7B is partially composed of a PES 41 and a PES 42 shown in FIG. 7A. Further, a TS 43 is assumed to have a frequency f40 as in the case of the first embodiment.

As in the case of the first embodiment, in this embodiment also, first, the PES 41 and the PES 42 are divided into parts each of which has a predetermined size to thereby generate partial PESs 41-1, 41-2, . . . , and PESs 42-1, 42-2, . . . , respectively.

Then, the TS 43 is composed by arranging TS packets each of which is formed by the partial PESs, at a predetermined time interval ti as shown in FIG. 7B. For example, when the TS 43 shown in FIG. 7B is received by a receiver 3, first after a TS packet 41-1p is received and the lapse of time ti elapses a TS packet 42-1p is received, and after another lapse of time ti elapses a TS packet 41-2p is received. It is to be noted that in this embodiment also, a header of each of the TS packets is provided with a PPID which indicates that they are formed from the partial PES. This holds true also with a third embodiment.

Moreover, TS having the respective frequencies to be emitted from each transponder are assumed to have the same configuration shown in FIG. 7B and, as in the case of the first embodiment, be synchronized between the transponders and then emitted. Specifically, TS packets that compose a TS having a frequency f50 different from the frequency f40 are assumed to be arranged at the time interval ti so that they may not be received simultaneously with TS packets that compose the TS 40.

On the other hand, the receiver 4 in this embodiment has a configuration shown in FIG. 4 as in the case of the first embodiment. For example, if the user has operated a wireless remote controller 31 to give an instruction to the effect that a channel ch40 should be received, as in the case of the first embodiment, a tuner section 23 is controlled to selectively receive a TS signal having the frequency f40, demodulate it, and output it to a demultiplexer section 24. Based on data of PSI, the demultiplexer section 24 separates and extracts the TS packets for each of desired components (video data, audio data and the like) and then outputs them to the following-stage decoder section 25-1.

In the decoder section 25-1, a PES is restored from the TS packets provided with the same PID, stored in a buffer temporarily, time-adjusted so that it can be reproduced at reproduction time based on information about this reproduction time provided to the PES, and sent out to an output processing section 26-1.

In this case, as shown in FIG. 7B, the TS signal is composed by arranging the TS packets at the predetermined time interval ti, so that even if, for example, a signal having any other frequency is received by the tuner section 23 at somewhere in this lapse of time ti, information of this channel ch40 is acquired without fail.

The following will describe operations in the case of receiving the channels ch40 and ch50 simultaneously when a TS signal is configured as described above. It is assumed that a signal of the channel ch50 is included in a TS signal having the frequency f50 different from the frequency f40.

It is assumed that the user has operated the wireless remote controller 31 to instruct to receive the channel ch50 while receiving the channel ch40 simultaneously. The control section 28 recognizes based on a signal from the wireless remote controller 31 that an instruction has been received to the effect that a simultaneous reception mode should be entered. Further, the control section 28 instructs the tuner section 23 to receive the channel ch40 and the channel ch50 simultaneously.

The tuner section 23 receives signals as making switchover at a predetermined timing between the TS signal frequency f40 of the channel ch40 and the TS signal frequency f50 of the channel ch50. This timing is explained below.

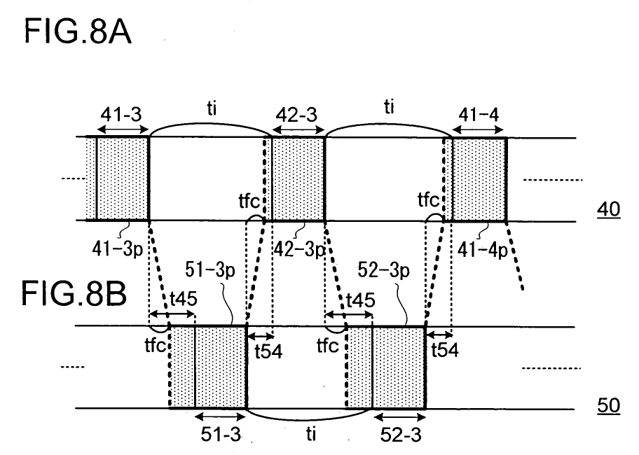

FIG. 8 shows a configuration example of TS signals of the channels ch40 and ch50 received by an antenna 21. In FIG. 8, (a) shows a configuration of a TS signal 40 of the channel ch40 and (b) shows a configuration of a TS signal 50 of the channel ch50.

TS packets are configured to have the same size and synchronized with each of TS signals when the TS signals are emitted from the transponder as described above, while the TS packets that compose the TS signal of the channel ch40 (whose frequency is f40) and the TS packets that compose the TS signal of the channel ch50 (whose frequency is f50) are configured so that they may not be received at the same timing as shown in FIG. 8.

In configuration, for example, when a TS packet 41-3p included in a TS 40 shown in FIG. 8 is made incident upon the antenna 21, a TS Packet 51-3p included in a TS 50 is yet to be made incident upon the antenna 21 but is done so when a predetermined lapse of time t45 elapses after the TS packet 41-3p is received. In this case, if a lapse of time tfc required in frequency switchover is shorter than t45, the TS packet 51-3p can be received by switching the frequency after the TS packet 41-3p is received.

Conversely, when the TS packet 51-3p included in the TS 50 is made incident upon the antenna 21, the TS packet 42-3p included in the TS 40 is yet to be made incident upon the antenna 21 but is done so after the TS packet 41-3p is received and a predetermined lapse of time t54 elapses. In this case, similarly, if tfc is shorter than t54, the TS packet 42-3p can be received by switching the frequency after the TS packet 51-3p is received.

It is to be noted that the TS 40 and the TS 50 are each composed by arranging TS packets having the same size at the predetermined time interval ti, so that it takes the constant lapse of time t45 to make the TS packet included in TS 50 incident upon the antenna 21 after an arbitrary one of the TS packets that compose the TS 40 is received and it takes the constant lapse of time t54 to, conversely, make the TS packet included in the TS 40 incident upon the antenna 21 after an arbitrary one of the TS packets that compose the TS 50 is received.

The following will describe a case where an instruction is given to simultaneously receive the channel ch50 when the channel ch40 is being received as described above in such a configuration.

The control section 28 instructs the tuner section 23 to receive the reception frequencies f40 and f50 simultaneously. It is assumed that, in this case, if a TS packet is being received, the STB 20 shifts into the simultaneous reception mode after this TS packet is received completely.

For example, it is assumed that the TS packet 41-3p is being received when the user has given an instruction to receive the channel ch50 simultaneously. In this case, the STB 20 shifts into the simultaneous reception mode after reception of this TS packet 41-3p is completed.

When the reception of the TS packet 41-3p is completed and the following TS packet 42-3p is received completely, the tuner section 23 switches the reception frequency from f40 to f50. In this case, since it takes some lapse of time to switch the frequency, if the lapse of time t45 required to make a TS packet with the frequency f50 incident upon the antenna 21 after completion of reception of the TS packets with the frequency f40 is set beforehand to a value larger than the lapse of time tfc required to complete frequency switchover, a TS packet 52-3p is yet to be made incident upon the antenna 21 at a point in time when the reception frequency is switched to the frequency f50.

The TS packet 42-3p received in this case is confirmed by the demultiplexer section 24 that its PID is “42p” and output to the decoder section 25-1. Based on that the PID is “42p” and the PPID is “p42p−3”, the decoder section 25-1 recognizes that the TS packet 42-3P is a partial PES 42-3 composed of one part of the PES 42 and stores it in the buffer until the other partial PESs required to restore the PES 42 are provided.

On the other hand, when a predetermined lapse of time elapses after the reception frequency is switched to f50 by the tuner section 23, a TS packet 52-3p is made incident upon the antenna 21. When having received this TS packet 52-3p, the demultiplexer section 24 confirms that a PID provided to its header is “52p” and outputs it to a decoder section 25-2.

Based on that the PID is “52p” and the PPID is “p52p-3”, the decoder section 25-2 recognizes that the TS packet 52-3p is a partial PES 52-3 composed of one part of a PES 52 and stores it in the buffer until the other partial PESs required to restore the PES 52 are provided.

When reception of the TS packet 52-3p is completed, the tuner section 23 switches the reception frequency from f50 back to f40. When a predetermined lapse of time elapses after completion of the frequency switchover, a TS packet 41-4p is made incident upon the antenna 21. When having received this TS packet 41-4p, the demultiplexer section 24 confirms that a PID provided to its header is “41p” and outputs it to the decoder section 25-1.

Subsequently, similarly, each time reception of a TS packet is completed, the tuner section 23 switches the reception frequency. Further, the demultiplexer section 24 confirms a PID and sends out data for the channel ch40 to the decoder section 25-1 and sends out data for the channel ch50 to the decoder section 25-2.

In such a configuration, when a TS signal with the frequency f40 is being received, a TS signal with the frequency f50 includes no TS packets to be received and, conversely, when a TS signal with the frequency f50 is being received, a TS signal with the frequency f40 includes no TS packets to be received. Therefore, by switching the reception frequency consecutively, it is possible to acquire all of TS packets required to restore a PES of each of both channels.

That is, as in the case of the first embodiment, for example, when all of TS packets (TS packets whose PID is “41p”) required to restore the PES 41 are stored in the buffer, the PES 41 is restored by using these TS packets in the decoder section 25-1, and when all of TS packets (TS packets whose PID is “52p”) required to restore the PES 52 are stored in the buffer, the PES 52 is restored by using these TS packets in the decoder section 25-2.

Data restored in the decoder section 25-1 is stored in the buffer temporarily, time-adjusted so that the data can be reproduced at reproduction time based on information about this reproduction time provided to this PES, and sent out to the output processing section 26-1. Similarly, data restored in the decoder section 25-2 is stored in the buffer temporarily, time-adjusted so that the data can be reproduced at reproduction time based on information about this reproduction time provided to this PES, and sent out to an output processing section 26-2. These data items are subjected to predetermined conversion processing at the output processing sections 26-1 and 26-2 respectively and output to an external device.

Therefore, the data (video, audio and the like) of the channel ch40 is output from the output processing section 26-1 and the data (video, audio and the like) of the channel ch50 is output from the output processing section 26-2, so that, for example, by connecting a TV set to the output processing section 26-1 and connecting a video cassette recorder to the output processing section 26-2 as described above, it is possible to respectively view and hear a video signal and an audio signal provided from the output processing section 26-1 while saving (video-recording) a video signal and an audio signal provided from the output processing section 26-2.

It is to be noted that the TS packets are configured to have the same size and it takes constant time to receive each of them completely, so that the tuner section 23 may switch the reception frequency consecutively each time a predetermined lapse of time elapses after it shifts into the simultaneous reception mode.

### Third Embodiment

The following will describe the third embodiment of the present invention with reference to the drawings. This embodiment is different from the first and second embodiments in configuration of a TS signal which is formed by a packet processing section 13 on the side of a transmission station 2 and hence in configuration of contents to be controlled by a control section 28 in a receiver 4 but are the same as the first embodiment in the other configurations, so that explanation of these configurations is omitted.

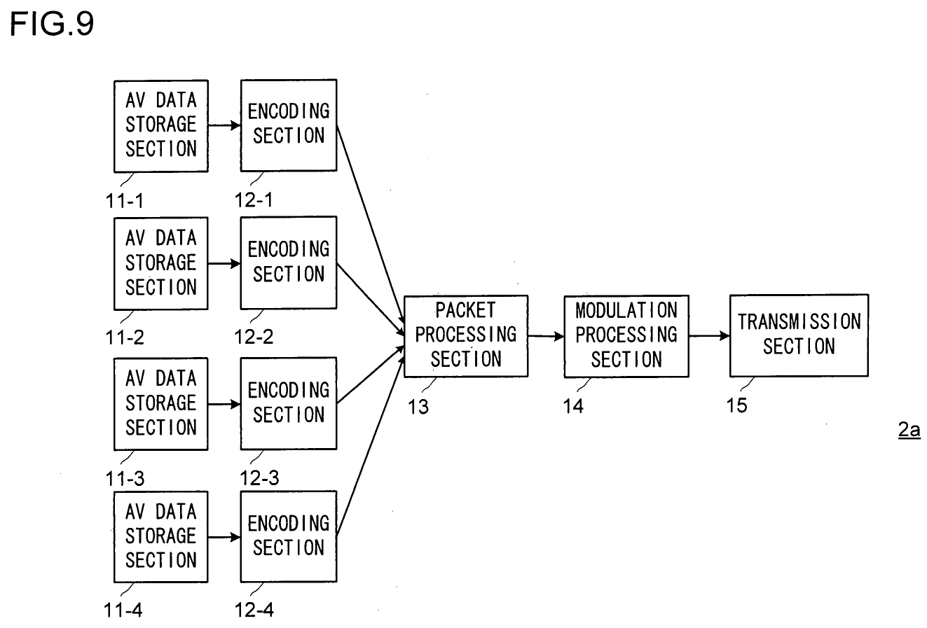

This embodiment employs such a configuration that a plurality of channels of programs is multiplexed into a TS signal having one frequency and transmitted from a transmission station. FIG. 9 is a block diagram showing a configuration of a transmission station 2a according to this embodiment. Although in the following description it is assumed that four channels of information are multiplexed into one TS, the number of the channels is not limited to four.

As shown in FIG. 9, in this embodiment, a plurality of channels of AV data pieces are stored in AV data storage sections 11-1 to 11-4, so that if AV data pieces of contents are provided from these storage sections to encoding sections 12-1 to 12-4 respectively, these encoding sections 12-1 to 12-4 digitally encodes the AV data to generate an ES and output it to the packet processing section 13.

The packet processing section 13 packetizes each predetermined unit of the ES of each of the channels provided from the encoding section 12 to thereby generate a PES and, further, divides (TS-packetizes) this PES into fixed-length portions and multiplexes them to thereby form a TS signal. In this case, each of the TS packets is provided with a packet ID (PID) for identification, and the TS packets obtained by dividing the same PES are provided with the same PID.

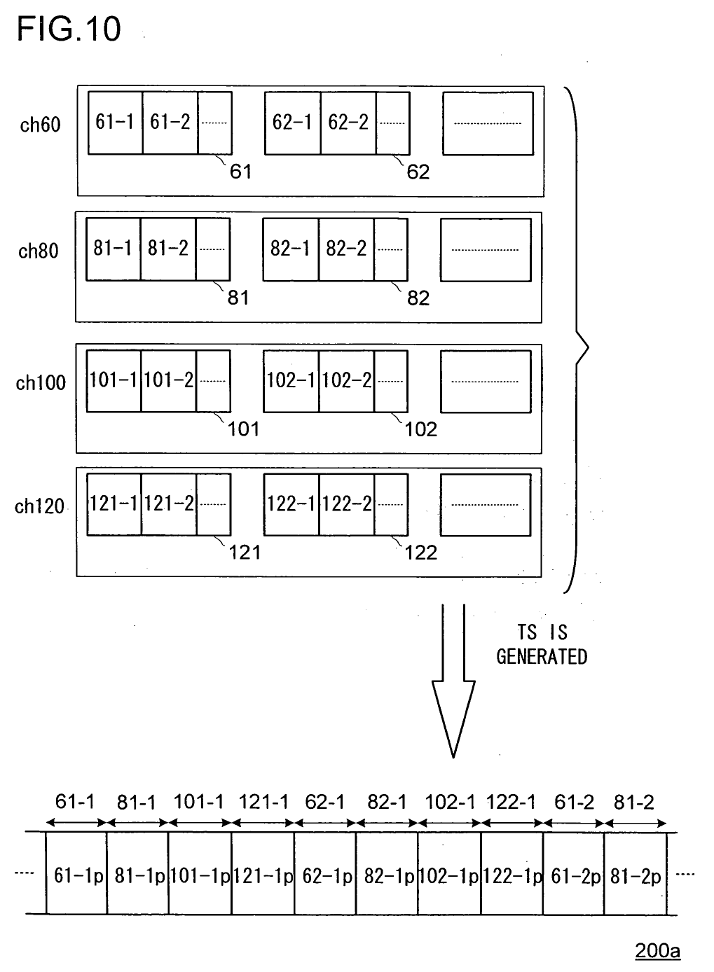

FIG. 10 shows one example of a TS packet string generated by the packet processing section 13. A single TS 200a shown in FIG. 10 is formed by multiplexing information pieces of four channels of ch60, ch80, ch100, and ch120.

An ES that corresponds to the AV data of the channel ch60 is composed of PESs 61, 62, . . . , and each of these PESs is divided into partial PESs 61-1, 61-2, . . . , 62-1, 62-2, . . . to thereby form TS packets. Further, similarly, PESs 81, 82, . . . that form an ES of ch80 are divided into partial PESs 81-1, 81-2, . . . , 82-1, 82-2, . . . to thereby form TS packets, PESs 101, 102, . . . that form an ES of ch100 are divided into partial PESs 101-1, 101-2, . . . , 102-1, 102-2, . . . to thereby form TS packets, and PESs 121, 122, . . . that form an ES of ch120 are divided into partial PESs 121-1, 121-2, . . . , 122-1, 122-2, . . . to thereby form TS packets.

In this case, like the first embodiment, each of the TS packets is provided with a packet ID (PID) for identification and TS packets into which the same PES is divided are provided with the same PID. Further, this TS signal is provided with PSI/SI in which information about each PES is described. This PSI/SI stores information about PESs that compose a TS packet, so that the receiver 4 can extract TS packets provided with a relevant PID based on this PSI/SI, to restore the PES from these TS packets. It is to be noted that in a configuration of this embodiment a plurality of channels are multiplexed into one TS signal, so that only a PES that corresponds to one channel specified by a user is restored.

When the TS signal formed by thus multiplexing a plurality of channels is transmitted from the transmission station 2, it is emitted to the receiver 4 via a transponder in a satellite 3. In the receiver 4, only a TS having one frequency specified by a tuner section 23 is received selectively and sent to a demultiplexer section 24 to be separated into the TS packets there. It is to be noted a frequency to be specified by the tuner section 23 is that of a TS that includes information of a channel specified by the user through a wireless remote controller 31.

The TS packets for the channel specified by the user is output to the following-stage decoder section 25-1 to restore a PES, which is time-adjusted so that it can be reproduced at reproduction time based on information about this reproduction time and sent out to an output processing section 26-1. In this case, TS packets not for the specified channel may not to be decoded.

According to an example shown in FIG. 10, if the user specifies any one of the channels ch60, ch80, ch100, and ch120, a reception frequency is specified by the tuner section 23 to f200 in order to receive the TS 200a (in this case the signal frequency of the TS 200a is assumed to be f200a), so that TS packets for the desired channel are decoded on the basis of this TS packet string to thereby restore the PES.

The following will describe the case of receiving a plurality of channels simultaneously in a situation where a plurality of channels of information are thus multiplexed into a TS. In the following description, it is assumed that while the channel ch60 multiplexed into a TS having the frequency f200a is being received, the channel ch90 multiplexed into a TS having another frequency of f200b is received.

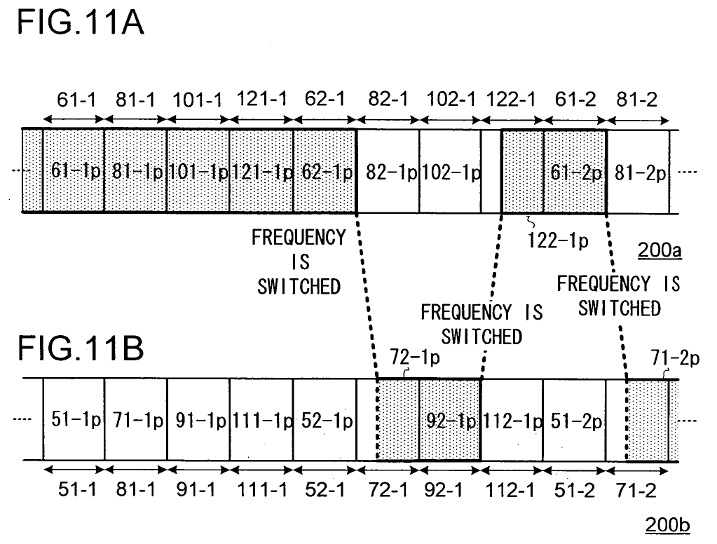

FIG. 11 shows one example of a configuration of the TS according to this embodiment. In FIG. 11, (a) shows a configuration of the TS 200a formed by multiplexing four channels ch60, ch80, ch100, and ch120 and (b) shows a configuration of a TS 200b formed by multiplexing four channels ch50, ch70, ch90, ch110. It is to be noted that the TS 200a has a signal frequency of f200a and the TS 200b has a signal frequency of f200b.

Further, as in the case of the aforementioned embodiments, it is assumed that TSs emitted from a transponder in the satellite 3 are synchronized with each other and TS packets that compose each of these TSs have the same size.

It is assumed that the user has operated the wireless remote controller 31 to instruct to receive the channel ch90 while receiving the channel ch60. The control section 28 recognizes based on a signal from the wireless remote controller 31 that it has received the instruction to the effect that a simultaneous reception mode should be entered. The control section 28 in turn instructs the tuner section 23 to receive the channels ch60 and ch90 simultaneously.

The tuner section 23 receives signals as making switchover at a predetermined timing between the TS signal frequency f200a including the channel ch60 and the TS signal frequency f200b including the channel ch90. This timing is explained below.

TS packets are configured to have the same size and synchronized with each of TS signals when the TS signals are emitted from the transponder as described above, so that the TS packets that compose the TS 200a and the TS packets that compose the TS 200b are made incident upon an antenna 21 at the same timing.

For example, when a TS packet 61-1p included in the TS 200a shown in FIG. 11 is made incident upon the antenna 21, simultaneously a TS packet 51-1p included in the TS 200b is also made incident upon the antenna 21, so that if the tuner section 23 is in such a condition that it can selectively receive the frequency f200a, it cannot receive the TS packet 51-1p.

Based on an instruction from the wireless remote controller 31, the control section 28 instructs the tuner section 23 to simultaneously receive the channels ch60 and ch90. In this case, it may be assumed that a fact that the signal frequency of a TS signal that includes the channel ch90 is f200b has been stored in a memory (not shown) beforehand. In such a case, the control section 28 instructs the tuner section 23 to receive a signal having the frequency f200b simultaneously.

For example, after the user completes reception of a TS packet for a channel ch60 that is received first since an instruction to receive the channel ch90 simultaneously is given, the tuner section 23 switches the reception frequency from f200a to f200b. For example, if a TS packet 81-1p is being received when the simultaneous reception instruction is given, the reception frequency is switched to f200b after reception of a TS packet 62-1p for ch60 to be provided next is completed.

In this case, it takes some lapse of time to switch the frequency, so that when the frequency is switched to f200b, the antenna 21 receives the TS 200b in which a TS packet 72-1p is partially deficient. When a TS packet 92-1p for the channel ch90 to be provided next to the packet 72-1p is received, the demultiplexer section 24 confirms that this TS packet is for the channel ch90 based on a PID provided to a header of this packet and outputs it to a decoder section 25-2.

When reception of the TS packet 72-1p is completed, the tuner section 23 switches the reception frequency back to f200a. In this case, similar to the above, it takes a constant lapse of time to switch the frequency, so that the antenna 21 receives the TS 200a in which a TS packet 122-1p is partially deficient. When a TS packet 61-2 for the channel ch60 to be provided next to the packet 122-1p is received, the demultiplexer section 24 confirms that this TS packet is for the channel ch60 based on a PID provided to a header of this packet and outputs it to the decoder section 25-1.

Subsequently, similarly, the tuner section 23 switches the reception frequency each time reception of a TS packet is completed. Further, the demultiplexer section 24 confirms a PID and sends out data for the channel ch60 to the decoder section 25-1 and data for the channel ch90 to the decoder section 25-2.

In the decoder sections 25-1 and 25-2, as in the case of the aforementioned embodiments, when all of TS packets required to restore each PES are stored in the buffer, the PES is restored from these TS packets, time-adjusted on the basis of reproduction time information, and sent out to the output processing sections 26-1 and 26-2 respectively.

In such a configuration, by multiplexing a plurality of channels of signals into one TS, TS packets for each of the channels are arranged at a predetermined time interval in the TS, so that in the aforementioned example when a TS packet for the channel ch60 included in the TS 200a with the frequency f200a is being received, the TS 200b having the frequency f200b includes no TS packet for the channel ch90 to be received, and conversely when a TS packet for the channel ch90 included in TS 200b having the frequency f200b is being received, the TS 200a having the frequency f200a includes no TS packet for the channel ch60 to be received. Therefore, by consecutively switching the reception frequency, it is possible to acquire all of TS packets required to restore PESs for both of the channels.

Although the aforementioned example has been described with reference to a case where a plurality of channels included in TS signals having different frequencies are received, it is unnecessary to switch the frequency by using the tuner section 23 in a case where specified channels are multiplexed into the same TS signal as in the case of combination of the channels ch60 and ch80 shown in FIG. 11 for example. A determination on this may be made by the control section 28.

Further, in the example shown in FIG. 11, in configuration, TS packets for the respective channels ch60 and ch50 are made incident upon the antenna 21 simultaneously, so that programs for these two channels cannot be received simultaneously. Therefore, such a configuration may be employed that if the user instructs, on the wireless remote controller 31, to receive the channel ch50 simultaneously when the channel ch60 is being received, the control section 28 determines whether this combination is capable of simultaneous reception and, if such is not the case, the user is notified of information to this effect.

Moreover, in this embodiment also, as in the case of the first embodiment, a TS packet string may be formed by serially arranging a plurality of TS packets in which the same information is described. In this case, the plurality of TS packets describing the same information is arranged for each channel and TS packets for a plurality of channels are multiplexed into the same TS.

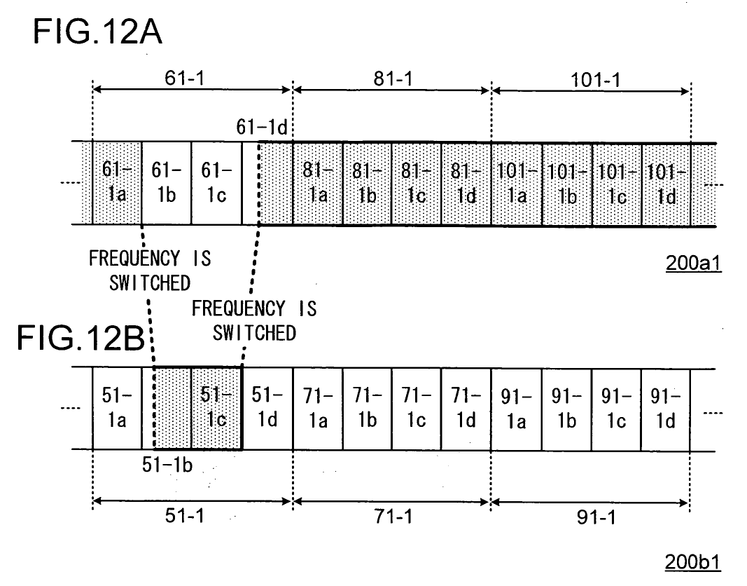

FIG. 12 shows a condition where the TS 200a and the TS 200b shown in FIG. 11 are further configured so that a plurality of the same TS packets are arranged serially (in which the corresponding TSs are assumed to be a TS 200a1 and a TS 200b1). In such a configuration, even if the user instructs to receive the channel ch50 simultaneously when the channel ch60 is being received, a TS packet 51-1c can be received by switching the frequency after a TS packet 61-1a is received, so that even such a channel combination that TS packets are given to the antenna at the same timing is capable of simultaneous reception.

It is to be noted in this embodiment that an order in which channels are arranged for each TS is stored beforehand in a memory (not shown), so that such a configuration may be employed that a timing for frequency switchover at the tuner section 23 is controlled in accordance with a channel specified by the user.

Although the aforementioned embodiments have been described with reference to the case of simultaneously receiving TS signals having two frequencies different from each other, such a configuration can be employed as to simultaneously receive at least three frequencies rather than the two frequencies. In this case, an STB 20 may be equipped with a plurality of decoder sections and a plurality of output processing sections so that at least three signals can be output.

Further, although in the aforementioned embodiments the STB has been equipped with a plurality of decoder sections, only a single decoder section may be equipped and decoded program data may be sent out to the output processing section for each channel as far as such a configuration is employed that data may be managed for each channel in a buffer equipped to the decoder section.

By thus configuring each TS signal and each STB in accordance with the aforementioned embodiments, it is possible to simultaneously receive a plurality of channels by using an STB equipped with a single tuner.

What is claimed is:

1. A digital satellite communication system comprising:
a transmission station for transmitting a signal including program information;
a satellite for relaying the signal transmitted from the transmission station; and
a receiver for receiving the signal relayed by the satellite to acquire the program information when predetermined processing is performed on the basis of the relayed signal, wherein
the receiver includes a tuner section for selecting a frequency of the signal to be received, and first and second output sections for outputting to an external device the program information acquired from the signal included in one frequency selected by the tuner section, and
when supplied with an instruction to receive a first channel included in the signal having a first frequency and a second channel included in the signal having a second frequency, the tuner section performs switchover control on the first frequency and the second frequency at a predetermined time interval, and the program information of the first channel is restored on the basis of the signal received, when the first frequency is selected, and sent out to the first output section and the program information of the second channel is restored on the basis of the signal received, when the second frequency is selected, and sent out to the second output section.

2. The digital satellite communication system according to claim 1, wherein
the transmission station includes an information division section for dividing the program information into packets, a multiplexing section for multiplexing, on the basis of a predetermined rule, the packets into which the information is divided by the information division section to thereby generate a stream, and a transmission section for transmitting to the satellite the stream generated by the multiplexing section,
the receiver includes a demultiplexing section for separating the multiplexed packets from the stream included in a signal having one frequency selected by the tuner section, and a decoding section for restoring the program information from the packets separated by the demultiplexing section, and
the program information provided by the decoding section is output to an external device from the first and second output sections.

3. The digital satellite communication system according to claim 2, wherein
the multiplexing section generates the stream by multiplexing the plurality of packets into which the information is divided by the information division section, as inserting predetermined idle-time into the packets so that the packets are discontinuous in a time-wise manner.

4. The digital satellite communication system according to claim 3, wherein
the predetermined idle-time inserted into the packets is provided in a different time zone for each frequency.

5. The digital satellite communication system according to claim 4, wherein
when the receiver is instructed to receive the first channel included in a signal having the first frequency and the second channel included in a signal having the second frequency, the tuner section acquires the program information of both of the channels by switching a reception frequency between the first frequency and the second frequency as utilizing the predetermined idle-time included in each of the streams.

6. The digital satellite communication system according to claim 3, wherein
the multiplexing section generates the stream by arranging a plurality of the packets in which the same information is described serially in the predetermined idle-time.

7. The digital satellite communication system according to claim 6, wherein
when the receiver is instructed to receive the first channel included in a signal having the first frequency and the second channel included in a signal having the second frequency, the tuner section acquires the program information of both of the channels by switching a reception frequency between the first frequency and the second frequency by utilizing time in which the packets in which the same information is described are provided.

8. The digital satellite communication system according to claim 3, wherein
the transmission station is provided with the program information for a plurality of channels,
the information division section divides the program information for the plurality of channels to thereby generate packets one for each channel, and
the multiplexing section generates the stream by multiplexing the program information of the plurality of channels by serially arranging the packets for any other channel in the predetermined idle-time.

9. The digital satellite communication system according to claim 8, wherein
when the receiver is instructed to receive the first channel included in a signal having the first frequency and the second channel included in a signal having the second frequency, the tuner section acquires the program information of both of the channels by setting the reception frequency to the first frequency in time when the packets for the first channel of the packets included in the signal having the first frequency are provided and switching the reception frequency to the second frequency in time when the packets for any channel other than the first channel are provided to receive the packets for the second channel.

10. The digital satellite communication system according to claim 3, wherein
the transmission station is provided with the program information for a plurality of channels,
the information division section divides the program information for the plurality of channels to thereby generate packets one for each channel, and
the multiplexing section generates the stream by arranging, in the predetermined idle-time, the packets for any other channel wherein
in the stream the plurality of packets in which the same information is described is arranged.

11. The digital satellite communication system according to claim 10, wherein
when the receiver is instructed to receive the first channel included in a signal having the first frequency and the second channel included in a signal having the second frequency, the tuner section acquires the program information of both of the channels by acquiring the packets for the first channel as setting the reception frequency to the first frequency in time when the packets for the first channel of the packets included in the signal having the first frequency are provided and by receiving the packets for the second channel as switching the reception frequency to the second frequency in time when the packets are provided in which the same information as that for the packets provided in the time in which the packets for the first channel are provided is described or in time when the packets for any channel other than the first channel are provided.

12. A transmission station equipped to the digital satellite communication system according to claim 2, wherein
the multiplexing section generates the stream by multiplexing the plurality of packets into which the information is divided by the information division section, as inserting predetermined idle-time into the packets so that the packets are discontinuous in a time-wise manner.

13. The transmission station according to claim 12, wherein
the predetermined idle-time inserted into the packets is provided in a different time zone for each frequency.

14. The transmission station according to claim 12, wherein
the multiplexing section generates the stream by multiplexing a plurality of the packets in which the same information is described, as arranging the packets serially in the predetermined idle-time.

15. The transmission station according to claim 12, being provided with the program information for a plurality of channels, wherein
the information division section generates packets by dividing the program information for the plurality of channels, and
the multiplexing section generates the stream by multiplexing the program information of the plurality of channels by serially arranging the packets for any other channel in the predetermined idle-time.

16. The transmission station according to claim 12, being provided with the program information for a plurality of channels, wherein
the information division section generates packets by dividing the program information for the plurality of channels, and
the multiplexing section generates the stream by arranging, in the predetermined idle-time, the packets for any other channel and serially arranging the plurality of packets in which the same information as that for the packets for the other any channel is described and multiplexing the packets.

17. A receiver equipped to the digital satellite communication system according to claim 1, wherein
when the receiver is instructed to receive the first channel included in a signal having the first frequency and the second channel included in a signal having the second frequency, the tuner section acquires the program information of both of the channels by switching a reception frequency between the first frequency and the second frequency as utilizing the predetermined idle-time included in each of the streams.

18. A receiver equipped to the digital satellite communication system according to claim 1, wherein
when the receiver is instructed to receive the first channel included in a signal having the first frequency and the second channel included in a signal having the second frequency, the tuner section acquires the program information of both of the channels by switching a reception frequency between the first frequency and the second frequency as utilizing time in which packets in which the same information is described are provided.

19. A receiver equipped to the digital satellite communication system according to claim 1, wherein
when the receiver is instructed to receive the first channel included in a signal having the first frequency and the second channel included in a signal having the second frequency, the tuner section acquires the program information of both of the channels by setting the reception frequency to the first frequency in time when the packets for the first channel of the packets included in the signal having the first frequency are provided and switching the reception frequency to the second frequency in time when the packets for any channel other than the first channel are provided to receive the packets for the second channel.

20. The receiver according to claim 18, when supplied with an instruction to receive the first channel included in the signal having the first frequency and a third channel included in the signal having the second frequency, notifying that only one of the channels can be received if a time zone in which the packets for the first channel of the packets included in the signal having the first frequency are provided and a time zone in which the packets for the third channel of the packets included in the signal having the second frequency are provided overlap with each other.

21. A receiver equipped to the digital satellite communication system according to claim 1, wherein
when the receiver is instructed to receive the first channel included in a signal having the first frequency and the second channel included in a signal having the second frequency, the tuner section acquires the program information of both of the channels by acquiring the packets for the first channel as setting the reception frequency to the first frequency in time when the packets for the first channel of the packets included in the signal having the first frequency are provided and by receiving the packets for the second channel as switching the reception frequency to the second frequency in time when the packets are provided in which the same information as that for the packets provided in the time in which the packets for the first channel are provided is described or in time when the packets for any channel other than the first channel are provided.
